(19) United States
(12) Patent Application Publication
(10) Pub. No.: US 2026/0265861 A1
(43) Pub. Date: Sep. 10, 2026

(54) SELECTIVE EXTRACTION OF RHODIUM FROM HYDROCHLORIC ACID SOLUTIONS COMPRISING RHODIUM AND IRIDIUM

(71) Applicants: JOHNSON MATTHEY PUBLIC LIMITED COMPANY, London (GB); THE UNIVERSITY COURT OF THE UNIVERSITY OF EDINBURGH, Edinburgh (GB)

(72) Inventors: Andrew CARRICK, Edinburgh (GB); Jason LOVE, Edinburgh (GB); Carole MORRISON, Edinburgh (GB); Paul Noel OSHAUGNESSY, Reading Berkshire (GB); Jane Helen PATRICK, Reading Berkshire (GB); Emma SCHOFIELD, Reading Berkshire (GB)

(21) Appl. No.: 18/872,067

(22) PCT Filed: Jun. 27, 2023
(86) PCT No.: PCT/GB2023/051672

§ 371 Date: Dec. 5, 2024

(30) Foreign Application Priority Data
Aug. 1, 2022 (GB) 2211199. 1

(51) Int. Cl. C22B 11/00; C22B 3/28; C22B 3/40

(52) U.S. Cl. CPC C22B 11/04; C22B 3/28; C22B 3/40

(57) ABSTRACT

A method of selectively extracting rhodium from an aqueous hydrochloric acid solution comprising rhodium and iridium, the method comprising: mixing a first aqueous hydrochloric acid solution comprising rhodium and iridium with an immiscible organic solution comprising a first organic solvent and an extractant system which selectively extracts the rhodium into the organic solution, wherein the first aqueous hydrochloric acid solution has a hydrochloric acid concentration in a range 2 M to 7 M; separating the organic solution comprising the rhodium from the first aqueous hydrochloric acid solution; mixing the separated organic solution with an aqueous stripping solution in order to strip the rhodium from the organic solution into the aqueous stripping solution; separating the organic solution from the aqueous stripping solution; and re-using the organic solution for further extraction of rhodium.

### FIELD

The present specification relates to a method and organic extractant composition for selectively extracting rhodium from hydrochloric acid solutions comprising rhodium and iridium.

### BACKGROUND

Rhodium is a rare platinum group metal (PGM) with a range of uses in chemical catalysis, electronics, and jewellery. However, its primary application is found in automotive catalytic converters, where it is used to reduce nitrous oxide emissions. In both virgin ores and secondary sources rhodium is typically found alongside other PGMs, from which it must be separated and purified. After concentration using pyrometallurgical processes, hydrometallurgy is frequently used. The hydrometallurgical process typically involves the oxidative leaching of the PGMs into hydrochloric acid, followed by separation using a sequence of solvent extraction, distillation or precipitation methods.

Developing a viable solvent extraction process for the recovery of rhodium from hydrochloric acid has proven challenging. Rhodium forms chloridometalates of the type [RhClₓ(H₂O)₆₋ₓ]⁽ⁿ⁻³⁾⁻ in dilute hydrochloric acid, with [RhCl₆]³⁻ and [RhCl₅(H₂O)]²⁻ the predominant complexes at industrially relevant concentrations of HCl, at least for the test solutions utilized in this work. The variable speciation means that there is not a single rhodium complex to target in the aqueous phase. Instead, a series of chloridometalates are present, with the exact composition dependent on the concentrations of HCl and rhodium as well as the temperature, pH and the age of the solution. The metalates found in industrially relevant HCl concentrations each present further challenges. The hexachlorido metalate [RhCl₆]³⁻ is a relatively small, charge-dense anion that has a high energy of hydration, disfavouring its extraction into a non-polar organic phase in accordance with the Hofmeister bias. Aquated rhodium complexes such as [RhCl₅(H₂O)]²⁻, are typically found in lower HCl concentrations and are difficult to extract into an organic phase due to their hydrophilicity. The lack of a commercially viable solvent process means that rhodium is often recovered using single-use precipitants at the end of the refining flowsheet, contributing to the high global warming potential of rhodium.

Due to their similar chemical and physical properties, the separation of rhodium and iridium is particularly difficult. Iridium is substitutionally inert compared with rhodium and forms the trianion [IrCl₆]³⁻ under typical refinery conditions. Its separation from rhodium is achieved by oxidation of Ir(III) to Ir(IV), so forming the dianion [IrCl₆]²⁻ which is more readily extracted than [RhCl₆]³⁻ into an organic phase. In order to avoid the oxidation step for iridium, and to recover the more valuable rhodium earlier in the process, it is desirable to develop a method for the selective solvent extraction of rhodium over iridium. Previous reports on the preferential extraction of rhodium over iridium have used tin chloride as a reducing and labilising agent, forming more extractable rhodium-tin complexes, but the tin and rhodium must subsequently be separated. Other systems which selectively extract rhodium over iridium use very low acid concentrations compared with those typically found in a refinery or they rely on the use of additives such as thiocyanate.

It has been found previously that the combination of a simple primary amine and simple primary amide synergistically extracts rhodium [see Carrick, A. I.; Doidge, E. D.; Bouch, A.; Nichol, G. S.; Patrick, J.; Schofield, E. R.; Morrison, C. A.; Love, J. B., Simple Amides and Amines for the Synergistic Recovery of Rhodium from Hydrochloric Acid by Solvent Extraction. Chem. Eur. J. 2021, 27 (34), 8714-8722]. Two different rhodium complexes were extracted into the loaded organic phase; the [RhCl₆]³⁻ metalate by protonated amines (2-ethylhexylamine) and a complex [RhCl₅(L)]²⁻ with an inner-sphere amide ligand L (3,5,5-trimethylhexanamide) as well as outer-sphere protonated amines. The inner-sphere complex was predominately extracted at low [HCl] whereas the outer-sphere complex was extracted from higher [HCl]. While this system is capable of extracting a high percentage of rhodium, little selectivity over other PGMs such as iridium was seen. The loss of the protonated extractants to the raffinate also prevented the reuse of the organic phase in further extraction steps.

It is an aim of the present specification to address the aforementioned problems.

### SUMMARY OF INVENTION

The present specification provides a method of selectively extracting rhodium from an aqueous hydrochloric acid solution comprising rhodium and iridium, the method comprising:
mixing a first aqueous hydrochloric acid solution comprising rhodium and iridium with an immiscible organic solution comprising a first organic solvent and an extractant system which selectively extracts the rhodium into the organic solution, wherein the first aqueous hydrochloric acid solution has a hydrochloric acid concentration in a range 2 M to 7 M;
separating the organic solution comprising the rhodium from the first aqueous hydrochloric acid solution;
mixing the separated organic solution with an aqueous stripping solution (e.g., a second aqueous hydrochloric acid solution which is stronger than the first aqueous hydrochloric acid solution) in order to strip the rhodium from the organic solution into the aqueous stripping solution;
separating the organic solution from the aqueous stripping solution; and
re-using the organic solution for further extraction of rhodium,
wherein the extractant system comprises:
   at least one ligand comprising a C₉ to C₄₀ alkyl or aryl group and a polar functional group which binds to the rhodium to form a complex;
   at least one charge stabilizing compound comprising a branched C₉ to C₄₀ alkyl group and a polar functional group which forms a counter-ion to stabilize the complex; and
   optionally a phase modifier in the form of a second organic solvent (e.g., one which is more polar than the first organic solvent).

The extractant systems of the present specification differ from the synergistic amide(ligand)/amine(charge stabilizer) system previously described in the background section in that a branched C₉ to C₄₀ alkyl group is provided in the charge stabilizing compound. The branched alkyl group of the charge stabilizing compound is preferably at least C₁₀, C₁₁, or C₁₂, optionally no more than C₃₀, and optionally comprises at least two branches, optionally at least three branches, with a chain length of at least C₂, C₃, C₄, C₅, C₆, C₇, or C₈. Furthermore, the branched alkyl group of the charge stabilizing compound is preferably branched at an α position next to the polar functional group of the stabilizing compound. Most preferably, the branched alkyl group of the charge stabilizing compound is a tert-alkyl group branched at the α position.

It has been found that by modifying the branched alkyl group of the charge stabilizing compound, the synergistic extraction system becomes selective for extraction of rhodium over iridium. Furthermore, increasing the chain length of the branched alkyl group reduces the loss of protonated stabilizing compounds to the raffinate, thus enabling the reuse of the organic phase in further extraction steps (noting that the polar functional group of the stabilizing compound is protonated to form the stabilizing counter-ion). Further still, the extraction system is able to selectively extract rhodium over iridium at hydrochloric acid concentrations used in industrial platinum group metal refining streams, i.e., hydrochloric acid concentrations of: at least 2 M, 2.5 M, 3M, or 3.5 M; no more than 7 M, 6 M, 5.5 M, or 5 M; or within a range defined by any combination of the aforementioned lower and upper limits. To our knowledge, this represents the first solvent extraction system which can preferentially extract rhodium over iridium from industrially relevant hydrochloric acid refining streams without the prior addition of SnCl₂ to form a rhodium-tin complex, which subsequently requires a rhodium-tin separation method, or the addition of other additives such as such as thiocyanate. The present system has been shown to exhibit a separation factor, defined by a distribution coefficient for rhodium divided by a distribution coefficient for iridium, which exceeds 10 within at least a portion of the hydrochloric acid concentration range 2 M to 7 M, noting that a separation factor of at least 10 is required for a good separation process.

It will be appreciated that a selective extraction of rhodium from an aqueous hydrochloric acid solution comprising rhodium and iridium does not require 100% extraction of rhodium and 0% extraction of iridium in a single extraction step. Extractions can be repeated on a solution to increase the extraction of rhodium and decrease the extraction of iridium, e.g., using one or more counter-current configurations. Furthermore, optionally a scrubbing step can be performed on the organic solution after extraction of rhodium and prior to stripping if residual iridium is present and requires removal. Alternatively, or additionally, rhodium could be selective stripped from the extractant relative to any residual iridium. However, to be selective, advantageously the extractant system exhibits a separation factor, defined by a distribution coefficient for rhodium divided by a distribution coefficient for iridium, which exceeds 10 within at least a portion of the hydrochloric acid concentration range 2 M to 7 M as previously indicated.

It will be appreciated that the extraction system is free, or at least substantially free, of tin. Furthermore, it will be appreciated that the ligand and the charge stabilizing compound are chemically different species fulfilling functionally different roles. For example, the ligand may be an amide and the charge stabilizing compound may be an amine such as a tert-alkyl primary amine. The ligand binds to the rhodium to form a complex while the charge stabilizing compound forms a counter-ion to stabilize the complex.

The polar functional group of the charge stabilizing compound may be selected from an amine (preferably a primary amine), an ammonium cation, a phosphine, a phosphonium cation or another group which can be protonated to form the stabilizing counter-ion. While primary aliphatic amines without branching at the α position are effective rhodium extractants, primary aliphatic amines with branching at the α position, such as tert-alkyl primary amines, do not extract rhodium under identical conditions on their own. Furthermore, primary amides do not extract rhodium when used individually. However, when the branched amine and amide are combined, a significant synergistic effect is observed with rhodium being transported into the organic phase as [RhCl₅]²⁻, with inner-sphere co-ordination of the amide to the metal considered important to the process. This results in the combination of extractants displaying a high degree of selectivity for rhodium over more inert iridium chloridometalates, a separation which has previously proven particularly challenging. The loaded rhodium may be stripped using more concentrated HCl solutions, and the extractant reused in multiple cycles

A mixture of the charge stabilizing compounds can be provided in the extractant system, the mixture of charge stabilizing compounds having different alkyl groups. The size and branching of the alkyl groups affects both the extraction functionality for rhodium and also the solubility of the compounds in the organic phase. To target both high loadings of the charge stabilizer in the organic phase and also a high degree of extraction and selectivity for rhodium, such a mixture may be utilized.

In addition to the modified charge stabilizing compounds as described above, it has also been found to be advantageous to provide a phase modifier in the extraction system in the form of a second organic solvent which is different to the first organic solvent of the organic solution. The second organic solvent can be selected to be more polar than the first organic solvent. Such a phase modifier is useful because during mixing of organic and aqueous phases, a third phase can form which is undesirable. The phase modifier prevents formation of such a third phase during mixing of the organic and aqueous phases. The phase modifier (i.e., the second organic solvent) may be a polar solvent selected from one or more of: an alcohol, optionally 1-octanol or 2-ethyl-1hexanol; an alcohol mixture (e.g., Exxal 10, Exxal 11, or Exxal 13); or an organo-phosphate, optionally tri-n-butyl phosphate. In contrast, the first organic solvent can be a non-polar hydrocarbon solvent selected from: straight chain, branched chain or cyclic aliphatic compounds, optionally hexane, cyclo-hexane, heptane, cycloheptane, octane, nonane, decane, undecane, dodecane; aliphatic mixtures of straight chain, branched chain or cyclic aliphatic compounds (e.g., high flash point kerosene, Shellsol D70, Escaid 110, Escaid 115, or Escaid 120); aromatic compounds, optionally toluene, p-xylene, o-xylene, m-xylene; or mixtures of aromatic compounds (e.g., Shellsol A, Aromatic 150, Solvesso 150, or Solvesso 150 ND).

Using the modified charge stabilizing compounds and phase modifier as described above, it has been found that the extraction system can function to selectively extract rhodium over iridium. The ligand can be a C₉ amide as described in the previous work discussed in the background section. However, such a ligand is partially washed into the aqueous stripping solution during the stripping process. As such, it has also been found to be advantageous to also modify the prior ligands by increasing the size of the alkyl or aryl group of the ligand to be at least C₁₀, C₁₁, or C₁₂, optionally no more than C₃₀. This modification prevents loss of the ligand into the aqueous phase during stripping and thus enables the organic extractant to be recycled and re-used. Branching can also be used to eliminate loss of ligand into the aqueous stripping solution. As such, the ligand may comprise a branched alkyl group and optionally such an alkyl group comprises at least two branches with a chain length of at least C₂, C₃, C₄, C₅, C₆, C₇, or C₈. Branching has also been found to help avoid a third phase formation during mixing of the organic extractant with aqueous solutions as well as preventing loss of the extractants into the aqueous phase. As with the charge stabilizing compound, a mixture of the ligands can be provided in the extractant system, said mixture of ligands having different alkyl groups balancing solubility requirements and extraction performance requirements.

The polar functional group which binds to the rhodium to form the complex advantageously does so by preferential inner sphere binding with the rhodium compared to the iridium, this difference in binding mechanism with the rhodium and iridium contributing to the selectivity of extraction for rhodium over iridium. At least 50%, 60%, 70%, 80%, or 90% of the complex can be extracted into the organic solution in the form of [RhCl₅(L)]²⁻, which is charge balanced by the charge stabilizing compound.

The polar functional group of the ligand may comprise an N-donor atom, an S-donor atom, an O-donor atom, or a P-donor atom which binds to the rhodium. Polar groups comprising an N-donor atom or an S-donor atom are preferred, most preferably an N-donor. In this regard, S-donor atoms can be prone to bind too strongly to rhodium making the stripping of rhodium from the loaded organic phase more difficult. Conversely, O-donor atoms can bind too weakly to rhodium making extraction less efficient. N-donor species have been found to provide a good balance between strength of binding for extraction and ability to strip the rhodium from the loaded organic phase after extraction. Examples of polar functional groups for the ligand include an amide, a primary amide, a sulfide, a sulfoxide group, an oxime, an aldoxime, a pyridine, a carboxylate, a thiol, a thioamide, a pyrazole, a sulfone, a thiophene, a phosphate, an alcohol, an ether, a phosphine, and a ketone.

Once the rhodium has been extracted into the organic solution, the organic solution is separated from the aqueous hydrochloric acid feed solution. Advantageous, the organic solution is then scrubbed with a scrubbing solution to remove iridium after separating the organic solution comprising the rhodium from the first aqueous hydrochloric acid solution and prior to stripping the rhodium from the organic solution.

After scrubbing, the rhodium can be stripped from the organic solution using an aqueous stripping solution. The aqueous stripping solution may comprise a mineral acid, optionally hydrochloric acid, nitric acid, or sulfuric acid, optionally having a concentration greater than that of the first aqueous hydrochloric acid solution. For example, the aqueous stripping solution may be a second aqueous hydrochloric acid solution having a hydrochloric acid concentration greater than that of the first aqueous hydrochloric acid solution. That said, it is also possible to use other stripping solutions, e.g., aqueous ammonia, to strip the rhodium from the organic solution, although use of an acid is preferred for further processing of the aqueous rhodium solution in a refinery. After stripping, the organic solution can be re-used for further extraction of rhodium, optionally following a washing step to remove entrained aqueous. This is of particular use where a non-acid stripping agent, such as ammonia or other alkaline reagents, has been used. As such, this methodology is more environmentally friendly and cost effective than using single-use reagents.

In order to increase the desired transfer of metal species between organic and aqueous phases in the various steps of the process, counter-current configurations can be utilized. Each counter-current configuration can comprise a plurality of mixer-settlers through which organic and aqueous phases are flowed in a counter current direction. Such a configuration can be used in any one or more of the extraction, scrubbing, and stripping processes.

While the above description summarizes a method of selectively extracting rhodium from an aqueous hydrochloric acid solution comprising rhodium and iridium, the present specification also provides an organic extractant solution for use in said method. The organic solution comprises: a first organic solvent which is immiscible with water; and an extractant system which is formulated to selectively extract rhodium from an aqueous hydrochloric acid solution comprising rhodium and iridium, wherein the extractant system comprises: at least one ligand comprising a C₉ to C₄₀ alkyl or aryl group and a polar functional group which binds to the rhodium to form a complex; at least one charge stabilizing compound comprising a branched C₉ to C₄₀ alkyl group and a polar functional group which forms a counter-ion to stabilize the complex; and optionally a phase modifier in the form of a second organic solvent which is different to the first organic solvent (e.g., more polar). Preferred features of such an organic extractant solution have already been summarized above in relation to the method and are not repeated here for conciseness.

### BRIEF DESCRIPTION OF THE DRAWINGS

For a better understanding of the present invention and to show how the same may be carried into effect, certain embodiments of the present invention will now be described by way of example only with reference to the accompanying drawings, in which:

FIG. 1 shows a flow chart of a method for selectively extracting rhodium;

FIG. 2 shows an illustration of a method for selectively extracting rhodium;

FIG. 3 shows an illustration of a counter-current configuration for selectively extracting rhodium;

FIG. 4 shows examples of amines which have been investigated as charge stabilizing compounds;

FIG. 5 shows an example of an amide which can be used as the extractant ligand;

FIG. 6 shows an example of a synergistic combination of an amine (charge stabilizer, L^{A}) and an amide (ligand, L¹) for use in the method of selectively extracting rhodium;

FIG. 7 shows UV-vis spectra of a rhodium-loaded organic phase comprising the amine and amide system of FIG. 6, the data indicating that the synergistic combination extracts rhodium in almost exclusively the [RhCl₅(L¹)]²⁻ metalate;

FIG. 8 shows an image of the biphasic extraction after contact but before phase separation;

FIG. 9 shows the time dependence of rhodium extraction using the synergistic mixture of the amide ligand and amine charge stabilizer shown in FIG. 6;

FIG. 10 shows NMR data of the organic phase loaded with rhodium (a) and not loaded with rhodium (b), the data indicating that the amide group is tautomerized and co-ordinated via the nitrogen atom;

FIG. 11 shows the % extraction of rhodium and iridium from a hydrochloric acid solution into the organic phase and the rhodium and iridium distribution coefficients between the organic and aqueous phases with varying HCl concentration, this data illustrating the preferential extraction of rhodium over iridium, particularly within a HCl concentration range between 2 M and 7 M;

FIG. 12 shows data for repeated extraction and stripping of rhodium using the synergistic amide/amine mixture of FIG. 6; and

FIG. 13 shows data for stripping of rhodium using a range of synergistic extraction systems.

### DETAILED DESCRIPTION

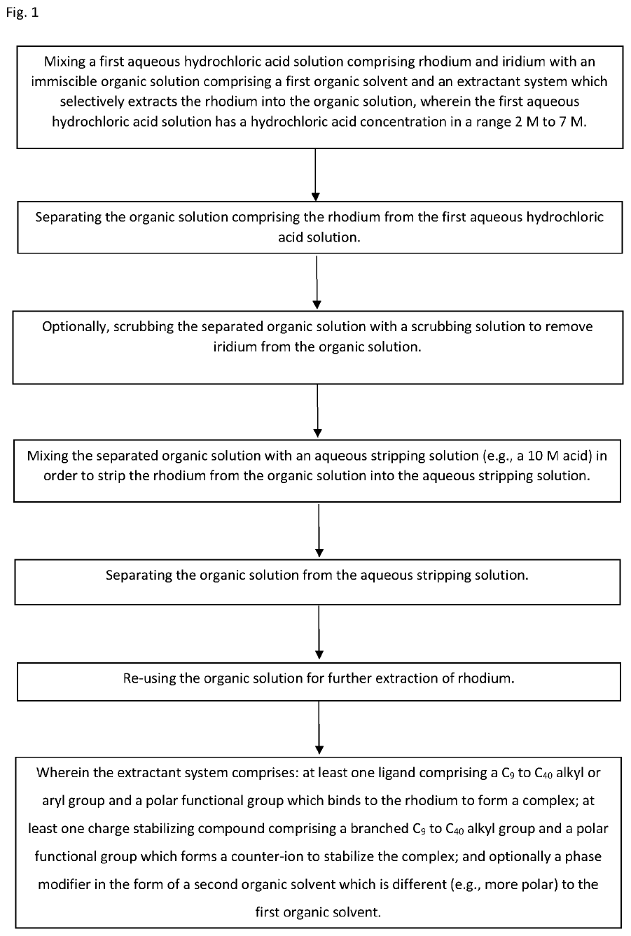

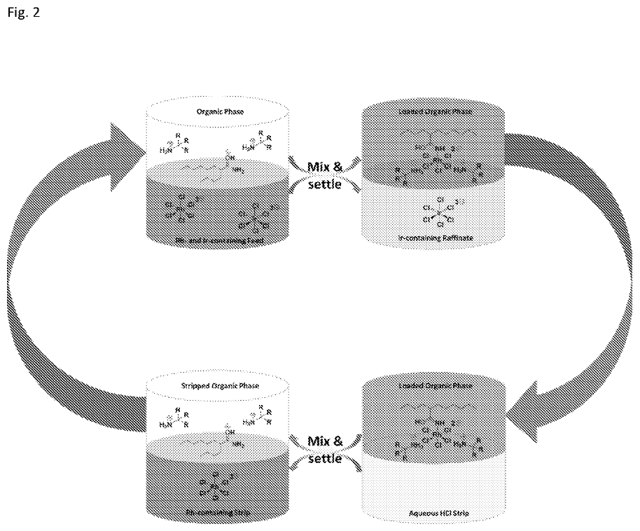

As described in the summary section and as illustrated in FIGS. 1 and 2, the present specification provides a method of selectively extracting rhodium from an aqueous hydrochloric acid solution comprising rhodium and iridium. The method comprises mixing a first aqueous hydrochloric acid solution comprising rhodium and iridium with an immiscible organic solution comprising a first organic solvent and an extractant system which selectively extracts the rhodium into the organic solution, wherein the first aqueous hydrochloric acid solution has a hydrochloric acid concentration in a range 2 M to 7 M. The organic solution comprising the rhodium is then separated from the first aqueous hydrochloric acid solution. The organic solution is advantageously then subjected to a scrubbing solution to remove iridium prior to mixing the separated organic solution with an aqueous stripping solution in order to strip the rhodium from the organic solution into the aqueous stripping solution. The organic solution can then be separated from the aqueous stripping solution and re-used for further extraction of rhodium. The aqueous stripping solution comprising rhodium can then be further processed to recover the rhodium in a desired form using known techniques.

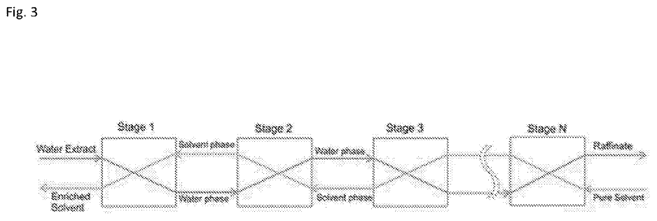

Counter-current configurations can be used for each of the extraction, scrubbing, and stripping steps. FIG. 3 shows a diagram of a counter current extraction process for the selective extraction of a metal from an aqueous feed solution into the organic phase. The aqueous feed is pumped through from left to right, and the organic phase is pumped from right to left. In each stage (which is usually a mixer-settler unit) the aqueous and organic phases are mixed, then allowed to separate before being pumped off to the next stage on the right or left respectively. Running a multi-stage process counter current enables the greatest possible concentration of desired metal, with the lowest concentration of unwanted metals, in the organic phase leaving the system with the lowest concentration of desired metal left in the raffinate. A plant would normally run counter current scrubbing and stripping circuits as well as for extraction.

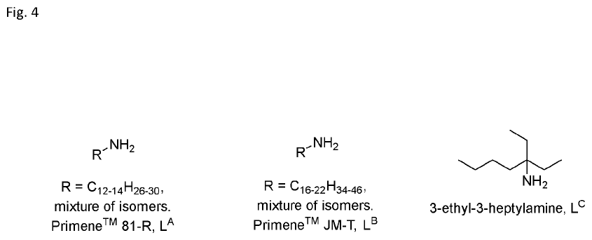

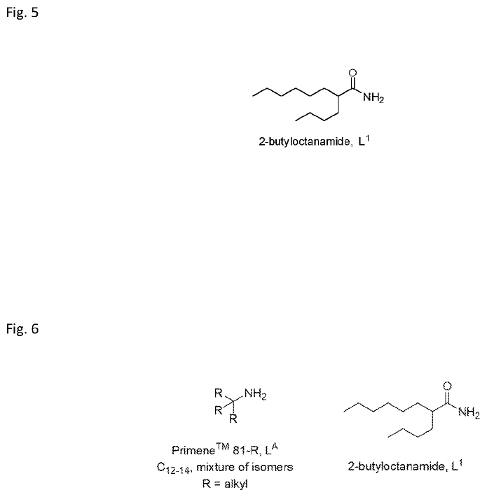

A key feature of the present specification is the use of an extractant system which comprises: at least one ligand comprising a C₉ to C₄₀ alkyl or aryl group and a polar functional group (e.g., an amide) which binds to the rhodium to form a complex; and at least one charge stabilizing compound (e.g., a tert-alkyl amine) comprising a branched C₉ to C₄₀ alkyl group and a polar functional group which forms a counter-ion to stabilize the complex. FIGS. 4 and 5 shows some of the amines and amides which have been assessed, while FIG. 6 shows an example of a synergistic combination comprising a tert-alkyl primary amine and a primary amide which can be used to selectively extract rhodium from hydrochloric acid. Negligible rhodium is extracted when using the primary amine (Primene™ 81-R, L^{A}) or the primary amide (2-butyloctanamide, L¹) individually, but combining the two reagents surprising results in selective rhodium extraction.

In relation to FIG. 6, the Primene™ reagent was obtained from Dow™. The 2-butyloctanamide reagent was synthesized as follows. To 2-butyloctanoic acid (7.8 mmol, 1.57 g), thionyl chloride (9.8 mmol, 0.72 mmol) was added. The mixture was refluxed for 1 hour, allowed to cool to room temperature, and attached to a scrubber containing aq. 15% NaOH. The reaction mixture was heated to remove excess thionyl chloride, allowed to cool to room temperature, dissolved in hexane (10 mL), and slowly added to aq. 35% NH₃ (30 mL) over ice followed by stirring at room temperature for 2 hours. The resultant white precipitate was extracted into DCM (dichloromethane, 30 mL) and washed with H₂O (2×10 mL) and brine (10 mL). The solution was dried over Na₂SO₄ and solvent removed by rotary evaporation. The product material in the form of a white solid was recrystallised from hot toluene and characterised by NMR:

¹H NMR (C₆D₆, 500 MHz) δ: 4.79 (s, 1H), 4.14 (s, 1H), 1.72-1.61 (m, 3H), 1.36-1.14 (m, 14H), 0.90 (t, 3H), 0.87 (t, 3H);

¹³C NMR (C₆D₆, 126 MHz) δ: 176.81, 47.22, 33.49, 33.19, 32.17, 30.19, 29.85, 28.00, 23.18, 23.06, 14.34, 14.24.

Table 1 below shows results for extraction of rhodium with L^{A}, L¹ and a mixture of L^{A} and L¹ under the following conditions: Rh (0.01 M) in HCl (4 M, 2 mL) aged for 1 day, contacted with L^{A} (2.25% v/v), L¹ (0.1 M), or a mixture of L^{A} and L¹ in an organic phase (2 mL) comprising toluene and 1-octanol (5% v/v) with stirring for one hour at room temperature.

% Rh extracted
into organic phase

| | No amide | L¹ |
|---|---|---|
| No amine | N/A | 0.5 |
| L^{A} | 1.5 | 29.1 |

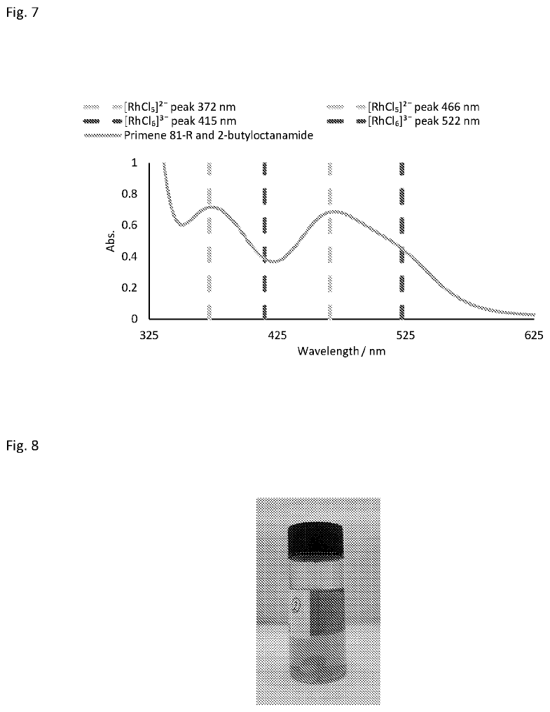

FIG. 7 shows a UV-visible (UV-vis) spectrum of the rhodium-loaded organic phase under the following conditions: Rh (0.01 M) in HCl (4 M, 2.5 mL) aged for 1 day, contacted with L^{A} (4.5% v/v) and L¹ (0.1 M) in an organic phase (2.5 mL) comprising toluene and 1-octanol (5% v/v) with stirring for 3 hours at room temperature. The UV-vis spectroscopy data indicates that the synergistic combination extracts almost exclusively the [RhCl₅(L¹)]²⁻ metalate. FIG. 8 shows an image of the biphasic extraction after contact but before phase separation.

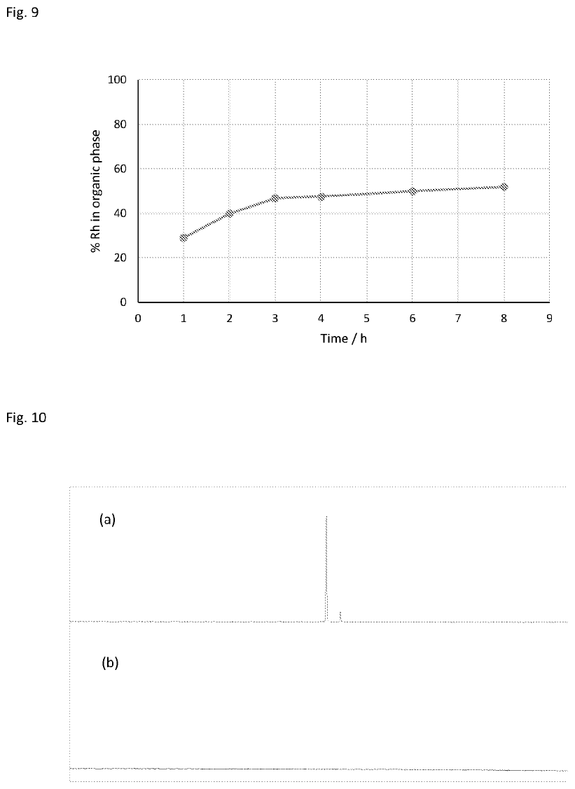

FIG. 9 shows the time dependence of rhodium extraction using a synergistic mixture of L^{A} and L¹. Extraction conditions are as follows: Rh (0.01 M) in HCl (4 M), aged for 1 day, contacted with L^{A} (2.25% v/v, approx. 0.1 M), L¹ (0.1 M) and 1-octanol (5% v/v) in toluene with stirring for 1-8 hours at room temperature. Furthermore, FIG. 10 shows ¹H NMR data of organic phases containing L^{A} and L¹, illustrating the region between 9.6 and 13.0 ppm for the following extraction conditions: (a) Rh (0.01 M) in HCl (4 M, 1.5 mL), aged for 1 day, contacted with L^{A} (4.5% v/v, approx. 0.1 M), L¹ (0.1 M) and 1-octanol (5% v/v) in toluene with stirring for 3 hours at room temperature; (b) HCl (4 M, 1.5 mL), contacted with L^{A} (4.5% v/v, approx. 0.1 M), L¹ (0.1 M) and 1-octanol (5% v/v) in toluene with stirring for 3 hours at room temperature. The relatively slow rate of extraction (as shown in FIG. 9) is suggestive of a mechanism which relies on inner-sphere co-ordination to the metal. NMR spectroscopy (as shown in FIG. 10) indicates that this complex is analogous to that observed in a previous amine/amide system [Carrick, A. I.; Doidge, E. D.; Bouch, A.; Nichol, G. S.; Patrick, J.; Schofield, E. R.; Morrison, C. A.; Love, J. B., Simple Amides and Amines for the Synergistic Recovery of Rhodium from Hydrochloric Acid by Solvent Extraction. Chem. Eur. J. 2021, 27 (34), 8714-8722], with the amide group tautomerized and co-ordinated via the nitrogen atom, and the [RhCl₅(L¹)]²⁻ charge-balanced by outer-sphere protonated amine molecules.

An important feature of the present specification is that it offers two important benefits over the previously published work. First, neither extractant is lost to the raffinate during contact with aqueous HCl, due to the increased length of the alkyl chains on each reagent. Secondly, by using a modified charge stabilizing amine (e.g., a tert-alkyl primary amine branched at the α position next to the NH₂ group), co-extraction of the hexachloridometalates [RhCl₆]³⁻ and [IrCl₆]³⁻ is significantly reduced. As the extraction therefore relies on the inner-sphere co-ordination of the primary amide, the more kinetically labile rhodium chloridometalates are preferentially extracted over iridium chloridometalates.

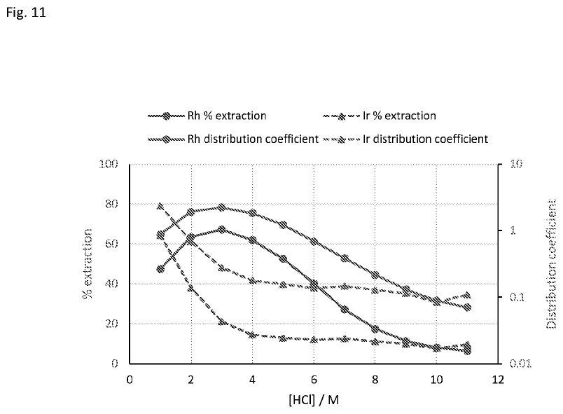

Selective extraction of rhodium over iridium is illustrated in FIG. 11 which shows extraction of rhodium and iridium from mixed-metal feed solutions of varying [HCl] by the synergistic mixture of L^{A} and L¹ under the following extraction conditions: Rh (0.01 M) and Ir (0.01 M) in HCl (1-11 M, 2 mL), aged for 1 day, contacted with L^{A} (4.5% v/v) and L¹ (0.1 M) in an organic phase (2 mL) comprising toluene and 1-octanol (5% v/v) with stirring for 3 hours at room temperature. As can be seen from the figure, between a hydrochloric acid concentration of 2 M and 7 M (which corresponds to concentrations used in industrial PGM refinery processes) significantly more rhodium is extracted than iridium.

FIG. 11 shows both % extraction of rhodium and iridium and also the distribution coefficient of rhodium and iridium. It should be noted that % extraction will vary with concentration of Rh and Ir metals in the aqueous feed. As such, the separation factor based on a ratio of distribution coefficients is a better measure of the selectively of the extraction system. In this regard, for two solutes/metals (Rh and Ir) which both extract into the organic phase, the separation factor is given by:

$$Separation Factor ( SF ) = {D}_{Rh} / {D}_{Ir}$$

where D_{Rh} is the distribution coefficient of rhodium and D_{Ir} is the distribution coefficient of iridium, the distribution coefficient for a metal given by:

$$D = [ Metal ] organic phase / [ Metal ] aqueous phase$$

A separation factor greater than 10 is shown in FIG. 11 within at least a portion of the [HCl] range 2 M to 7 M noting that a separation factor of at least 10 is required for a good process. As such, it has been demonstrated that extraction systems according to the present invention can be utilized to selectively extract rhodium over iridium. As previously indicated in the summary section, to our knowledge, this represents the first solvent extraction system which can preferentially extract rhodium over iridium from industrially relevant hydrochloric acid refining streams without the prior addition of SnCl₂ or other additives which require subsequent separations.

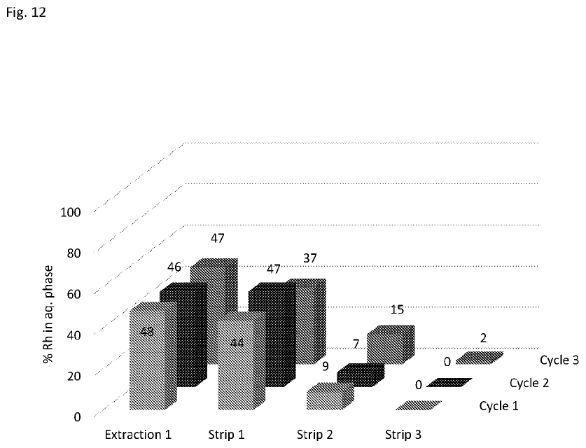

In addition to showing selective extraction of rhodium, it is also important to be able to strip the rhodium from the organic extractant solution. This has also been demonstrated. For example, FIG. 12 shows repeated extraction and stripping of rhodium using the synergistic mixture of L^{A} and L¹. Extraction conditions are as follows: Rh (0.01 M) in HCl (4 M) aged for 1 day, contacted with L^{A} (4.5% v/v) and L¹ (0.1 M) in an organic phase of equal volume comprising toluene and 1-octanol (5% v/v), with stirring for 3 hours at room temperature. Stripping conditions are as follows: Rh-loaded organic phase contacted with a fresh HCl solution (10 M) of equal volume with stirring for 1 hour at room temperature. At high concentrations of HCl, the large excess of chloride competes for inner-sphere binding sites, hence reducing the extraction by preventing coordination of the amide to the rhodium. The same principle may be applied to strip the rhodium from the metal loaded organic phase, as excess chloride displaces the amide and strips the rhodium into a fresh aqueous phase. Through multiple contacts with 10 M HCl the rhodium can be totally stripped, and the organic phase recycled through multiple extraction/stripping cycles.

While the example described above is based on a primary amide and a tert-alkyl primary amine system, other synergistic combinations can be used. Areas for improvement over 2-butyloctanamide include: improved solubility in organic solvents, which will allow for higher loadings and improved extraction; improving the separation factor between rhodium and iridium; and improving stripping of the loaded organic phase. A number of N-donor, S-donor and O-donor inner-sphere ligands have been screened. The screening process includes calculating the exchange energy between a chloride ligand and the ligand under investigation. The more negative the exchange energy, the more favourable the binding of the inner-sphere organic ligand. It is clear from the data so far that usually the binding of ligands with S-donor or N-donor atoms is more favourable than those with O-donor atoms. To date, this trend has been supported experimentally. Table 2 below shows exchange energy for the replacement of an inner-sphere chloride ligand on [RhCl₆]³⁻ with an inner-sphere organic ligand.

| | Exchange energy/kJ |
|---|---|
| Compound | mol − 1 |
| Dioctyl pyridine-3,5-dicarboxylate (N) | −614 |
| 3,5-ditertbutyl-2-hydroxy benzaldoxime (N) | −593 |
| 2-ethylhexylthiol (S) | −574 |
| Dihexylsulfide (S) | −573 |
| Dihexylsulfoxide (S) | −572 |
| 3-hexylpyridine (N) | −572 |
| 2-butyloctane thioamide (S) | −563 |
| 3,5-dimethylpyrazole (N) | −559 |
| 2-butyloctanamide (N) | −551 |
| Dihexylsulfone (O) | −536 |
| 3-hexylthiophene (S) | −535 |
| Tributylphosphate (O) | −532 |
| 1-octanol (O) | −532 |
| Dihexylether (O) | −526 |
| Dihexylsulfoxide (O) | −512 |
| Trioctylphosphine oxide (O) | −507 |
| Methyl isobutyl ketone (O) | −504 |
| 2-butyloctane thioamide (N) | −501 |

### General Experimental Procedures for Testing of the Aforementioned Synergistic Extractant Systems

### Solvent Extractions

An aqueous phase containing metal salt (0.01 M) in varying concentrations of aqueous HCl (0-12 M, 2 mL) is contacted with an organic phase (2 mL) containing extractants in toluene and 1-octanol for 1-8 h at room temperature with magnetic stirring. After mixing and phase disengagement, the phases are separated.

### Stripping of Loaded Organic Phase

The post-extraction organic phase is contacted with an aqueous stripping solution at room temperature with magnetic stirring. After mixing and phase disengagement, the phases are separated.

### ICP-OES/MS Analysis

Following phase separation, an internal standard (1000 ppm, 0.1 mL) and 1-methoxy-2-propanol (9.8 mL) are added to a sample (0.1 mL). This is repeated in duplicate for both the organic and aqueous phases. Samples can be analysed on a Perkin Elmer Optima 8300 Inductively Coupled Plasma Optical Emission Spectrometer (ICP-OES) or equivalent. Aqueous phase samples can be diluted ×1000 in 2% HNO₃ and analysed on an Agilent 7900 Inductively Coupled Plasma Mass Spectrometer (ICP-MS) or equivalent. Samples may also be diluted in methoxy propanol for analysis on an ICP-MS and diluted in HNO₃ (e.g., 2%) for analysis on an ICP-OES.

### UV-Vis Spectrophotometry

The neat organic phase solutions from solvent extraction experiments can be analysed against a solvent blank over the range 300-800 nm on a Shimadzu UV-1900 spectrometer or equivalent.

### NMR Spectroscopy

NMR spectra can be recorded on Bruker AVA500 or AVA600 spectrometers (or equivalent) at 300 K and at 500 or 600 MHz for ¹H and 126 or 151 MHz for ¹³C. Spectra can be referenced internally to residual protio solvent, and chemical shifts reported in δ (ppm).

### Alternatives to Primary Amides

A range of alternative inner-sphere ligands, which could potentially be used synergistically alongside Primene™ 81-R, were screened computationally and then tested experimentally. Structures of inner-sphere ligands investigated are illustrated below:

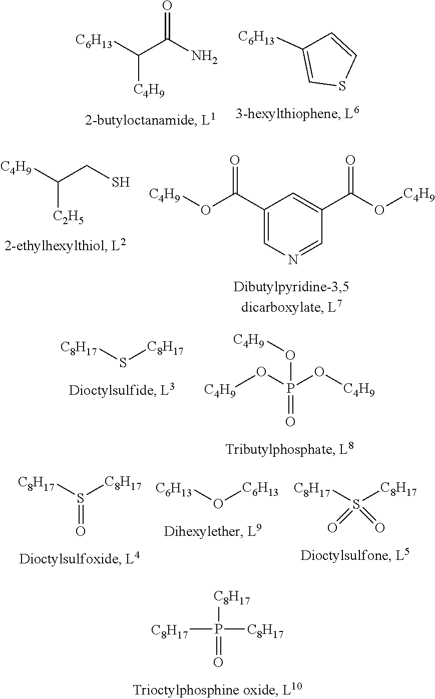

Computationally calculated exchange energies for the replacement of a chloride ligand in [RhCl₆]³⁻ with an inner-sphere organic ligand ([RhCl₆]³⁻+L→[RhCl₅(L)]²⁻+Cl⁻) are indicated in the below table.

| | Exchange energy/kJ |
|---|---|
| Compound | mol⁻¹ |
| Dibutylpyridine-3,5-dicarboxylate, L⁷ | −605 |
| 2-ethylhexylthiol, L² | −574 |
| Dioctylsulfide, L³ | −573 |
| Dioctylsulfoxide, L⁴ | −572 |
| 2-butyloctanamide, L¹ | −551 |
| Dioctylsulfone, L⁵ | −549 |
| 3-hexylthiophene, L⁶ | −535 |
| Tributylphosphate, L⁸ | −532 |
| Dihexyl ether, L⁹ | −526 |
| Trioctylphosphine oxide, L¹⁰ | −507 |

Experimental extraction data is show in the table below. Extraction conditions were as follows: Rh (0.01 M) in HCl (4 M, 2 mL) aged for 1 day, contacted with Ligand (0.1 M) individually or synergically with Primene™ 81-R (2.25% v/v, approx. 0.1 M) in an organic phase (2 mL) comprising toluene and 1-octanol (5% v/v) and stirred for 1 or 72 hours at room temperature.

| | % Rh extracted | | | |
|---|---|---|---|---|
| | Individ- | Individ- | Syner- | Syner- |
| | ual | ual | gistic | gistic |
| | (1 h | (72 h | (1 h | (72 h |
| Compound | contact) | contact) | contact) | contact) |
| Dibutylpyridine-3,5- | 0 | 0 | 0 | 44 |
| dicarboxylate, L⁷ | | | | |
| 2-ethylhexylthiol, L² | 0 | 0 | 3 | 81 |
| Dioctylsulfide, L³ | 0 | 0 | 0 | 44 |
| Dioctylsulfoxide, L⁴ | 0 | 0 | 8 | 97 |
| 2-butyloctanamide, L¹ | 0 | 0 | 30 | 52 |
| Dioctylsulfone, L⁵ | 0 | 0 | 9 | 98 |
| 3-hexylthiophene, L⁶ | 0 | 0 | 0 | 0 |
| Tributylphosphate, L⁸ | 0 | 0 | 2 | 1 |
| Dihexyl ether, L⁹ | 0 | 0 | 0 | 1 |
| Trioctylphosphine oxide, L¹⁰ | 0 | 0 | 0 | 1 |

The experimental data shows that using the inner-sphere ligands individually results in no Rh extraction whereas synergistic use with the amine results in Rh extraction. While the exact order of extraction with the synergistic combination doesn't exactly match what is predicted computationally (lots of other factors contribute experimentally), the cut-off between extraction/no extraction does match.

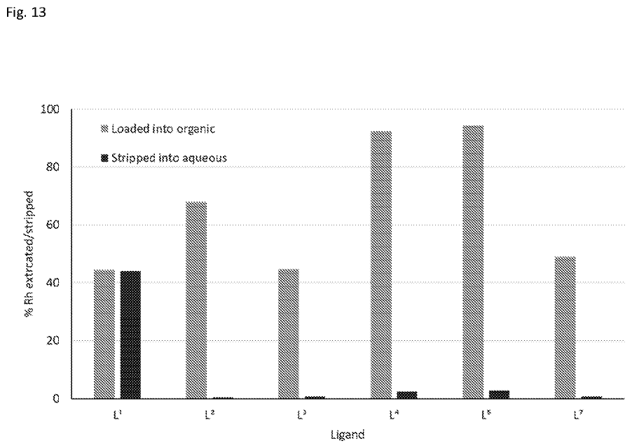

After a 72 hour synergistic extraction, the six inner-sphere ligands which extracted the most Rh were contacted with 10 M HCl for 1 hour. Stripping conditions were as follows: HCl (10 M, 1.5 mL), contacted with the loaded organic phase (1.5 mL), and stirred for 1 hour at room temperature. Results are shown in FIG. 13. Results indicated that Rh stripping is far more effective for the amine/amide (L¹) loaded organic phase under these stripping conditions when compared to the other extractant systems.

While this invention has been particularly shown and described with reference to certain examples, it will be understood to those skilled in the art that various changes in form and detail may be made without departing from the scope of the invention as defined by the appended claims.

1. A method of selectively extracting rhodium from an aqueous hydrochloric acid solution comprising rhodium and iridium, the method comprising:
mixing a first aqueous hydrochloric acid solution comprising rhodium and iridium with an immiscible organic solution comprising a first organic solvent and an extractant system which selectively extracts the rhodium into the organic solution, wherein the first aqueous hydrochloric acid solution has a hydrochloric acid concentration in a range 2 M to 7 M;
separating the organic solution comprising the rhodium from the first aqueous hydrochloric acid solution;
mixing the separated organic solution with an aqueous stripping solution in order to strip the rhodium from the organic solution into the aqueous stripping solution;
separating the organic solution from the aqueous stripping solution; and
re-using the organic solution for further extraction of rhodium,
wherein the extractant system comprises:
at least one ligand comprising a C₉ to C₄₀ alkyl or aryl group and a polar functional group which binds to the rhodium to form a complex comprising an N-donor atom, an S-donor atom, an O-donor atom, or a P-donor atom which binds to the rhodium; and
at least one charge stabilizing compound comprising a branched C₉ to C₄₀ alkyl group and a polar functional group selected from an amine or an ammonium cation which forms a counter-ion to stabilize the complex,
wherein the at least one ligand and the at least one charge stabilizing compound are chemically different species, and
wherein the branched alkyl group of the charge stabilizing compound is branched at an α position next to the polar functional group of the stabilizing compound.

2. The method according to claim 1,
wherein the branched alkyl group of the charge stabilizing compound is at least C₁₀, C₁₁, or C₁₂.

3. (canceled)

4. The method according to claim 1,
wherein the branched alkyl group of the charge stabilizing compound is a tert-alkyl group.

5. The method according to claim 1,
wherein the branched alkyl group of the charge stabilizing compound comprises at least two branches, optionally at least three branches, with a chain length of at least C₂, C₃, C₄, C₅, C₆, C₇, or C₈.

6. The method according to claim 1,
wherein the polar functional group of the stabilizing compound is protonated to form the stabilizing counter-ion.

7. (canceled)

8. The method according to claim 1,
wherein the polar functional group of the charge stabilizing compound is a primary amine.

9. The method according to claim 1,
wherein a mixture of the charge stabilizing compounds is provided in the extractant system, said mixture of charge stabilizing compounds having different alkyl groups.

10. The method according to claim 1,
wherein the extractant system further comprises a phase modifier in the form of a second organic solvent which is different to the first organic solvent, optionally wherein the second organic solvent is more polar than the first organic solvent, optionally wherein the second organic solvent is a polar solvent selected from one or more of: an alcohol, optionally 1-octanol or 2-ethyl-1hexanol; an alcohol mixture; or an organo-phosphate, optionally tri-n-butyl phosphate.

11. (canceled)

12. (canceled)

13. The method according to claim 1,
wherein the first organic solvent is a non-polar hydrocarbon solvent selected from: straight chain, branched chain or cyclic aliphatic compounds, optionally hexane, cyclo-hexane, heptane, cycloheptane, octane, nonane, decane, undecane, dodecane; aliphatic mixtures of straight chain, branched chain or cyclic aliphatic compounds; aromatic compounds, optionally toluene, p-xylene, o-xylene, m-xylene; or mixtures of aromatic compounds.

14. The method according to claim 1,
wherein the alkyl or aryl group of the ligand is at least C₁₀, C₁₁, or C₁₂.

15. The method according to claim 1,
wherein the alkyl or aryl group of the ligand is a branched alkyl group, optionally wherein the branched alkyl group of the ligand comprises at least two branches with a chain length of at least C₂, C₃, C₄, C₅, C₆, C₇, or C₈.

16. (canceled)

17. (canceled)

18. The method according to claim 1,
wherein the polar functional group of the ligand which binds to the rhodium to form the complex comprises an N-donor atom or an S-donor atom.

19. The method according to claim 1,
wherein the polar functional group of the ligand which binds to the rhodium to form the complex is selected from an amide, a primary amide, a sulfide, a sulfoxide group, an oxime, an aldoxime, a pyridine, a carboxylate, a thiol, a thioamide, a pyrazole, a sulfone, a thiophene, a phosphate, an alcohol, an ether, a phosphine, and a ketone.

20. The method according to claim 1,
wherein a mixture of the ligands is provided in the extractant system, said mixture of ligands having different alkyl groups.

21. (canceled)

22. (canceled)

23. (canceled)

24. (canceled)

25. The method according to claim 1,
wherein the aqueous stripping solution comprises a mineral acid, optionally hydrochloric acid, nitric acid, or sulfuric acid, optionally having a concentration greater than that of the first aqueous hydrochloric acid solution.

26. (canceled)

27. The method according to claim 1,
further comprising scrubbing the organic solution with a scrubbing solution to remove iridium after separating the organic solution comprising the rhodium from the first aqueous hydrochloric acid solution and prior to stripping the rhodium from the organic solution.

28. (canceled)

29. An organic solution for use in the method according to claim 1, the organic solution comprising:
a first organic solvent which is immiscible with water; and
an extractant system which is formulated to selectively extract rhodium from an aqueous hydrochloric acid solution comprising rhodium and iridium,
wherein the extractant system comprises:
at least one ligand comprising a C₉ to C₄₀ alkyl or aryl group and a polar functional group which binds to the rhodium to form a complex comprising an N-donor atom, an S-donor atom, an O-donor atom, or a P-donor atom which binds to the rhodium;
at least one charge stabilizing compound comprising a branched C₉ to C₄₀ alkyl group and a polar functional group which forms a counter-ion to stabilize the complex; and
optionally a phase modifier in the form of a second organic solvent which is different to the first organic solvent,
wherein the at least one ligand and the at least one charge stabilizing compound are chemically different species, and
wherein the branched alkyl group of the charge stabilizing compound is branched at an α position next to the polar functional group of the stabilizing compound.
